(19) United States
(12) Patent Application Publication
(10) Pub. No.: US 2024/0422808 A1
(43) Pub. Date: Dec. 19, 2024

(54) NETWORK RESOURCE MANAGEMENT BASED ON DYNAMIC INTELLIGENT PRICING MODEL

(71) Applicant: DISH Wireless L.L.C., Littleton, CO (US)

(72) Inventors: Mehdi Alasti, Arlington, VA (US); Kazi Bashir, Lewisville, TX (US); Siddhartha Chenumolu, Ashburn, VA (US); Marc Rouanne, Cherry Hills Village, CO (US)

(21) Appl. No.: 18/610,647

(22) Filed: Mar. 20, 2024

Related U.S. Application Data
(60) Provisional application No. 63/508,452, filed on Jun. 15, 2023.

(51) Int. Cl. H04W 72/53; G06Q 30/0201

(52) U.S. Cl. CPC H04W 72/53; G06Q 30/0206

(57) ABSTRACT

Systems and methods are provided for offering tenants the ability to purchase commoditized network resources in a next-generation, large-scale wireless communication network (e.g., a 5G or 6G cellular network) according to dynamic pricing. For example, the network can update pricing of commoditized network resources intelligently and dynamically based on present and/or predicted supply and/or demand of the network resources. The updated pricing is offered to tenants on a periodic or other basis, and the tenants can decide whether to purchase more or less of those resources based on the updated pricing. The network can adjust resource allocations to the tenants based on the updated purchase decisions. The network can also automatically adjust QoS parameters for the tenants to fit within their purchased resource allocations.

### CROSS REFERENCE TO RELATED APPLICATIONS

This application claims priority to U.S. Provisional Patent Application No. 63/508,452, filed on Jun. 15, 2023, the disclosure of which is incorporated by reference in its entirety for all purposes.

### BACKGROUND

In modern large-scale wireless communication systems, network service providers typically offer subscribers communications services at an agreed-upon quality of service (QoS) in exchange for a particular price. In fourth-generation (4G) and other legacy wireless communication networks, the service provider allocates network resources to a subscriber based on a service level agreement (SLA). The SLA informs a network function, such as a policy and charging rules function (PCRF), to implement QoS policies based at least on the subscriber's profile and service requirements. In such legacy wireless communication networks, the QoS policies tend to be implemented in a fixed manner and cannot be dynamically changed in response to changes in resource availability, or for other reasons.

More recently, fifth-generation (5G) wireless communication networks have added several network functions to facilitate dynamic policy updates, third-party quality adjustment requests, and other features. Further, recent developments in wireless communications have introduced cloud-native architectures, virtualized network functions, and other technologies to support multi-tenancy, different verticals, slice-based resource allocation and management, and other network improvements. Even with these improved network capabilities, communication services continue to be offered to subscribers based on flat-rate pricing of an agreed-upon QoS. Effectively, subscribers purchase a particular QoS, and the network operator seeks to allocate resources to satisfy the purchased QoS.

### BRIEF SUMMARY

Embodiments described herein facilitate commoditized resource allocation based on intelligent supply-demand-based pricing models. Rather than providing subscribers with a fixed-price SLA based on an agreed-upon QoS (i.e., QoS is effectively the commodity being bought and sold), embodiments provide a pricing interface for negotiation, between a network orchestration function and network service tenants, of a commodity price for network resources determined based on a present supply-demand model. Responsive to a successful negotiation with a network service tenant, the network orchestrator function generates a corresponding network resource adjustment request to adjust the network resources allocated to the network service tenant. The network service tenant can then issue a QoS policy adjustment request via a QoS interface based on the adjusted allocated resources. In some embodiments, a policing function determines whether the QoS policy adjustment request is allowed or denied based within network resource constraints associated with the adjusted allocated resources.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a second label, or a dash and a second label, that distinguishes among the similar components. If only the first reference label is used in the specification, the description is applicable to any one of the similar components having the same first reference label irrespective of the second reference label.

FIG. 1 shows a simplified block diagram of a relevant portion of a legacy wireless communication system.

FIG. 2 shows a high-level view of an example architecture for a wireless communication network.

FIG. 3 shows a simplified block diagram of a next-generation wireless communication network architecture supporting dynamic control of commoditized session-allocatable network resources (CSANRs), according to embodiments described herein.

FIG. 4 shows a flow diagram of a method for negotiated allocation of commoditized network resource management in a wireless communication network, according to embodiments described herein.

### DETAILED DESCRIPTION

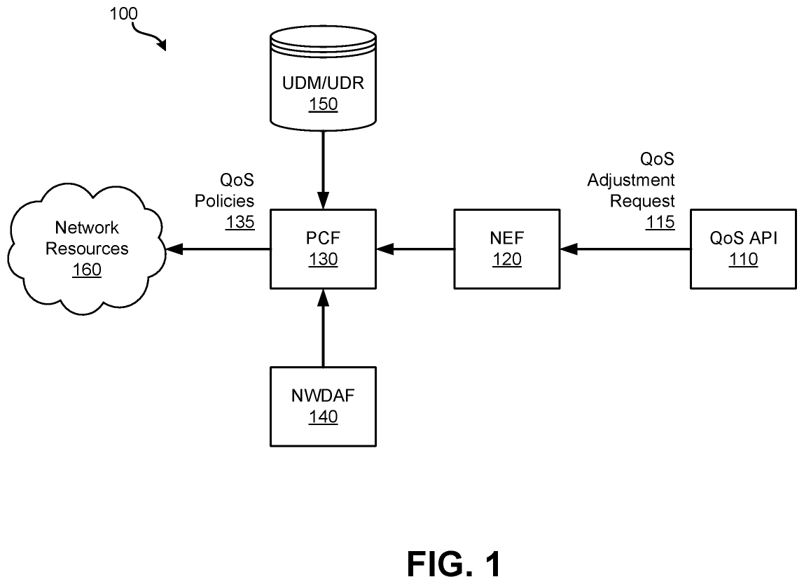

FIG. 1 shows a simplified block diagram of a relevant portion of a legacy wireless communication system 100. The illustrated portion of the legacy wireless communication system 100 shows both fourth generation (4G) and fifth generation (5G) network functions as a context for describing features of embodiments herein. In particular, the illustrated portion includes a quality of service (QoS) application programming interface (API) 110, a network exposure function (NEF) 120, a policy control function (PCF) 130, unified data management (UDM) and unified data repository (UDR) functions 150, and a network data analytics (NWDAF) function 150. Generally, the wireless communication network has network resources 160 (e.g., bandwidth), and QoS policies define the manner in which those resources are allocated by the network service provider. For example, QoS policies can define throughput, bit rate, latency, priority, packet error rate, packet loss, etc.

Generally, the UDR and UDM functions 150 are used to store and retrieve subscriber information and subscription information (e.g., a subscriber's service level agreement, SLA), respectively. An SLA is a formally structured document between a service provider (i.e., a cellular communication services provider) and a cellular customer that outlines mutual understanding and expectations pertaining to the quality and availability of the services provided. The SLA typically includes key performance indicators (KPIs), measurable benchmarks for service delivery, frameworks for accountability, remedies in case of service failures, and other important information.

As illustrated, the PCF 130 generally controls allocation of network resources in accordance with defined QoS policies based on the subscriber and subscription information provided by the UDR and UDM functions 150. In 4G wireless communication networks the PCF 130 is referred to as a policy and charging rules function (PCRF). When a subscriber connects to the network, the PCRF receives authentication and authorization information from the UDM (e.g., subscriber profile information, subscription details, and policy rules). The PCRF then determines an appropriate allocation of network resources based on the received information and availability of resources, such as determining how to allocate relevant available resources to enforce QoS policies (to provide an agreed-upon QoS). The PCRF can then allocate the appropriate network resources to the subscriber, such as by allocating bandwidth, priority, etc. The PCRF can then monitor usage of the network resources by the subscriber during a subscriber's session, such as to apply charging rules based on usage metrics (e.g., session duration, amount of data used, etc.). The PCRF can monitor and adjust resource allocations to maintain enforcement of the QoS policies and/or other policies. In 5G networks the PCF 130 operates in a similar manner to the PCRF, with some additional features. For example, the PCF 130 can control and enforce QoS and other policy decisions with more granular control over network functions, applications, and services; and the PCF 130 can define and control policy rules differently for different network slices, different verticals, different sessions, different tenants, etc. (taking advantage of features enabled by virtualized network functions, orchestration, and other 5G technologies).

5G wireless communication networks support additional features by providing additional network functions, such as the illustrated QoS API 110, NEF 120, and NWDAF 140. The NEF 120 generally provides an interface via which other network functions and applications can securely and controllably access information in network data repositories, such as the UDR. A QoS API 110 can be a standardized interface to the NEF 120 (e.g., it can be a function of the NEF 120, or separate therefrom) that provides third-parties with the ability to make QoS adjustment requests 115. The NEF 120 can determine, responsive to such QoS adjustment requests 115, whether the third-party is authorized to make such a QoS adjustment request 115 (e.g., whether the third-party has appropriate authorization or authentication to access and/or change relevant information in network data repositories). As described below, 5G networks can include an orchestrator function to manage (e.g., monitor, direct, etc.) virtualized network functions, applications, interfaces, services, etc. In some cases, the NEF 120 helps the orchestrator function by providing the orchestration function with a consolidated source of information different network data repositories, such as regarding available network resources, capabilities, service requirements, etc.

The NWDAF 140 is generally responsible for making decisions and predictions based on collecting and analyzing network-related information, such as user session information, network resource usage information, QoS parameter information, subscriber location and mobility information, etc. The NWDAF 140 can analyze the network-related information using various data processing techniques, such as pattern recognition, statistical analyses, data mining, machine learning, etc. Network functions can adjust resource allocations, traffic steering, load balancing, and/or other network parameters based on analyses performed by the NWDAF 140. For example, the NWDAF 140 can provide the PCF 130 with recommendations for how to define and/or enforce QoS policies 135 based on real-time network information, trend analyses and predictions, and/or the like. For example, analyses made by the NWDAF 140 can be used to predict times of high or low demand for network resources; times of potential network outages, service issues, or anomalies; etc.

In 5G networks, a customer may be able to issue a QoS adjustment request 115 via the NEF 120 (e.g., and/or via the QoS API 110). Typically, prior to making the QoS adjustment request 115, the NEF 120 authenticates and/or authorizes the customer by verifying credentials (e.g., an API key, authorization token, etc.) against its access control policies. The QoS adjustment request 115 can then be submitted and typically includes information, such as a subscriber identifier (e.g., a subscriber permanent identifier (SUPI), IP address, etc.), session information (e.g., session identifiers, flow descriptions, etc.), and requested QoS parameters (e.g., guaranteed bit rate (GBR), maximum bit rate (MBR), packet delay budget (PDB), and packet error rate (PER), etc.). The NEF 120 can process the QoS adjustment request 115, such as by validating the request 115 against network policies and the subscriber's service profile, translating the request 115 into network-level QoS parameters understandable by the core network and/or other functions, and notifying and/or instructing other functions (e.g., the PCF 130, session management function (SMF), etc.) regarding applying the requested QoS settings. Typically, the PCF 130 converts the QoS adjustment request 115 into corresponding QoS policies 135 (e.g., policies and QoS rules determined based on the request 115, the subscriber's profile, and/or other information), and one or more other network functions (e.g., the SMF) applies the QoS policies 135 to the subscriber's session or sessions. Subsequent to applying the requested QoS changes, the NEF 120 can send confirmation of the applied adjustments to the requesting customer.

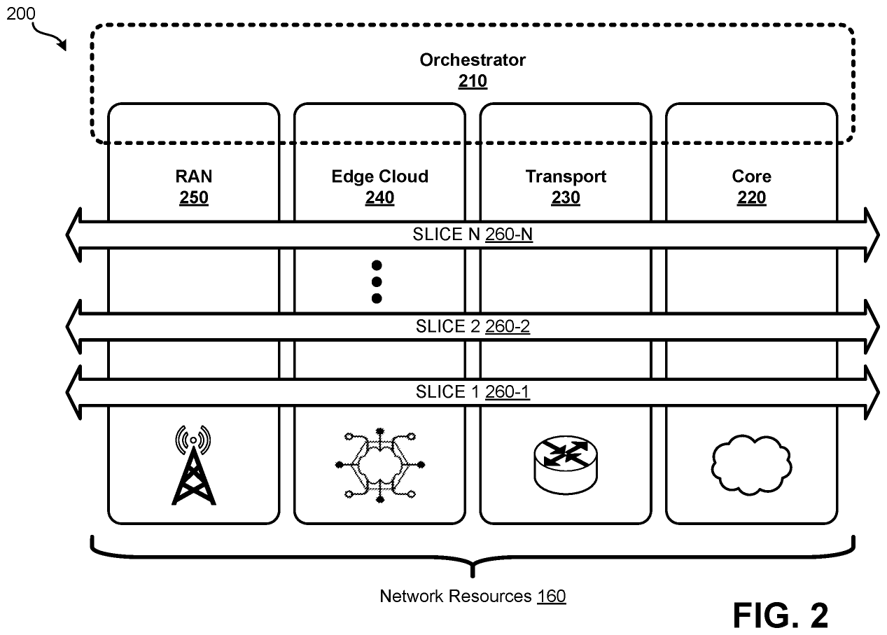

FIG. 2 shows a high-level view of an example architecture 200 for a wireless communication network. The architecture 200 is typical of a 5G architecture, and essentially the same architecture is expected to apply to sixth generation (6G) wireless communication networks and possibly to other next-generation wireless communication networks. The illustrated network is a cloud-native network implemented with virtualized network functions. As illustrated, the architecture 200 includes a radio access network (RAN) sub-architecture 250, an edge cloud sub-architecture 240, a transport sub-architecture 230, and a core sub-architecture 220. Centralized control of the various sub-architectures is managed and performed by a network orchestrator function 210.

The network orchestrator function 210 can provide several features. One example feature facilitated by the network orchestrator function 210 is end-to-end service orchestration and interconnectivity for services across virtualized network functions and domains. For example, such a feature can help to increase interoperability, decrease faults and failures, etc. Another example feature facilitated by the network orchestrator function 210 is coordination of allocations and optimizations of network resources 160. The network resources 160 in this context can include those described above as conventionally relating to QoS policies, such as bandwidth, latency, priority, etc. In the case of a cloud-native 5G architecture, such as illustrated in FIG. 2, the network resources 160 coordinated by the network orchestrator function 210 can also include resources, such as memory resources, storage resources, energy resources, virtualized processor (e.g., vCPU) resources, etc. As illustrated, the network resources 160 can include any session-allocatable resources from across all the sub-architectures of the network. Although not explicitly shown in FIG. 2, the network orchestrator function 210 can coordinate with the PCF 130 (see FIG. 1) to manage the network resources 160 in satisfaction of QoS policies 135 (see FIG. 1). Additionally, although not explicitly shown in FIG. 2, some of the features provided by the network orchestrator function 210 can be informed by monitoring changes in supply and demand for network resources 160, including based on reports, analyses, and/or other information received from the NWDAF 140 (see FIG. 1).

In the 5G context, the network can be segmented into virtual network instances, referred to as network slices 260 (shown as “slice 1” 260-1-“slice N” 260-N). The term “slice” is used herein in a manner consistent with its 5G network slicing meaning. Such network slicing is a network virtualization approach that facilitates creating multiple virtual networks on top of a common physical infrastructure (i.e., the architecture and sub-architectures shown in FIG. 2). Each slice 260 is essentially a logically independent, end-to-end network that is dynamically created with specific network functions, resources, and configurations to serve a particular purpose or set of service requirements. Network slicing provides several features. One feature is isolation. Different slices 260 can be logically isolated from other slices 260 to ensure that operations, traffic, and resources of one slice 260 do not interfere with those of others. Such isolation can be implemented at the physical layer (e.g., by dedicating hardware resources to particular slices), at the network layer, at various service levels, etc. Another feature is customization. Each slice 260 can be customized (tailored) with specific network functions, capabilities, performance parameters (e.g., bandwidth, latency, reliability, security, etc.), and/or other characteristics. For example, one slice 260 can be tailored for enhanced mobile broadband (eMBB), another slice 260 can be tailored for massive machine-type communications (mMTC), and another slice 260 can be tailored for ultra-reliable and low-latency communications (URLLC). Another feature is “dynamicity.” Slices 260 can be dynamically created, modified, and decommissioned based on changes in demand, which can provide flexible and efficient use of network resources 160.

Thus, each slice can be tailored and optimized for specific purposes, such as for a particular network tenant (e.g., enterprise subscriber), a particular vertical or service type (e.g., security cameras, voice calls, video streaming, etc.), and/or for other purposes. The orchestration features provided by the network orchestrator function 210 can be managed at the slice level. For example, each tenant, vertical, service type, etc. can be associated with one or more QoS policies 135 (see FIG. 1), and the network orchestrator function 210 can manage network resources 160 to satisfy each of those QoS policies 135.

As used herein, “tenants” generally refer to any distinct enterprise, entity, organization, user, or the like that uses or occupies a portion of the network infrastructure. 5G wireless communication networks support so-called “multi-tenancy”; multiple tenants can be occupying the network at the same time, each with its own resource allocations, policies, agreements, applications, etc. For example, the wireless communication network is segmented into different network slices (virtualized network instances), and each network slice 260 can be allocated to a tenant to provide the tenant with tailored functionality (e.g., tailored QoS, security, etc.), resource isolation from other tenants and/or verticals, etc. Specifications relating to each tenant can be defined at least partially according to SLAs between each tenant and the network operator or service provider.

For example, each slice 260 shown in FIG. 2 can be allocated to a respective tenant, or multiple slices 260 can be allocated to a same tenant. The network can be segmented into any feasible number of slices 260 for any feasible number of tenants. N slices 260 are shown, and N can be any positive integer. For example, the N slices 260 can include tens, hundreds, or thousands of slices 260.

Currently, wireless communication networks are implemented so that tenants purchase services (e.g., applications, verticals, etc.) associated with particular QoS parameters, and the network orchestrator function 210 manages network resources in a manner that satisfies those QoS parameters for the tenants. In contrast, embodiments herein offer a session-allocatable subset of the network resources 160 as commodities, which are referred to herein as commoditized session-allocatable network resources (CSANRs). Tenants are provided with an interface by which to negotiate direct purchases of CSANRs (e.g., amounts of resources at negotiated unit prices), and the tenant can control how those purchased CSANRs are used to realize certain QoS policies, charging policies, etc.

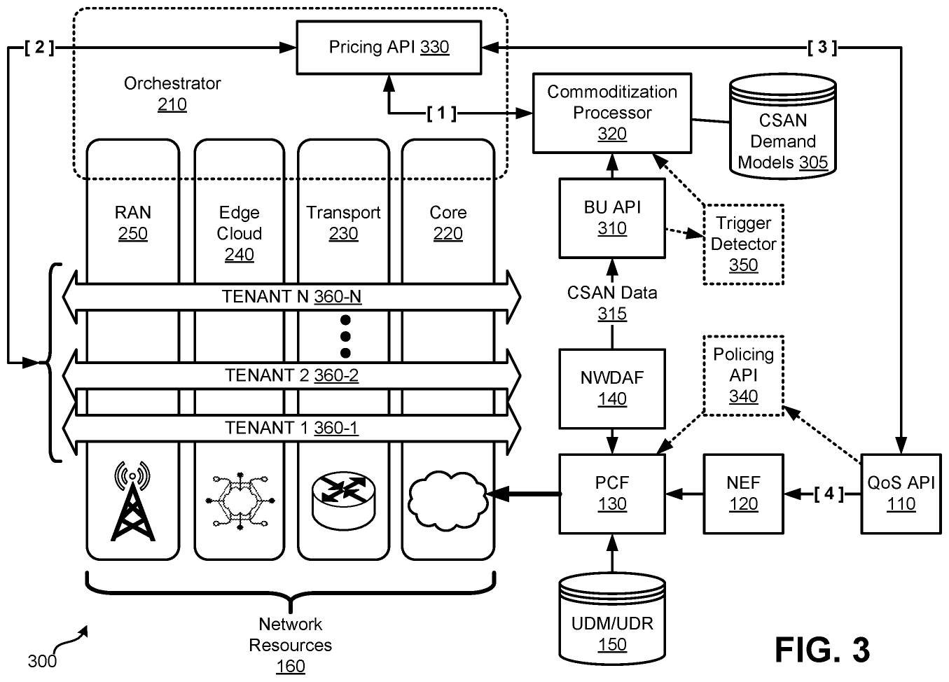

FIG. 3 shows a simplified block diagram of a next-generation wireless communication network architecture 300 supporting dynamic control of commoditized session-allocatable network resources (CSANRs), according to embodiments described herein. The architecture 300 can be implemented by a 5G wireless communication network, a 6G wireless communication network, or any suitable next-generation wireless communication network. For the sake of comparison, some portions of the network are illustrated in the same way as in FIGS. 1 and 2. Similarly illustrated components with the same labels can be implemented in substantially the same manner described above, except for any modifications needed to interface with additional components of FIG. 3.

As illustrated, the architecture 300 of FIG. 3 additionally includes some or all of a business unit (BU) API 310, a commoditization processor 320, a pricing API block 330, and a policing API block 340. At a first stage (indicated by the arrow labeled ‘[1]’), the commoditization processor 320 determines a present demand model for one or more CSANRs (illustrated as CSANR demand models 305). The CSANRs can include bandwidth resources, spectrum resources, data rate resources, memory resources, vCPU resources, storage resources, energy resources, multi-cloud resources, resources of particular network functions with particular capabilities, and/or any other network resources 160 that can be commoditized and allocated to one or more sessions. In the context of FIG. 2, network resources 160 were illustrated as allocated to slices 260. In the context of FIG. 3, network resources 160 were illustrated as allocated to tenants 360. As described herein, a particular tenant 360 can represent one or more slices 260. For example, meeting QoS requirements and/or other provisions of an SLA with a tenant 360 can involve allocating network resources 160 to one or more slices 260.

As illustrated, the commoditization processor 320 is in communication with the NWDAF 140 via the BU API 310. The commoditization processor 320 can use the BU API 310 to request and receive relevant information from the NWDAF 140 on present resource usage, predicted resource usage (e.g., trends, statistics, etc.), and/or other relevant information. In particular, as illustrated, the commoditization processor 320 can receive CSANR data 315, which can include any data relevant to generating and/or updating the CSANR demand models 305. For any particular CSANR, the commoditization processor 320 uses the information from the NWDAF 140 to account for present and/or predicted supply, demand, and/or any other relevant factors to generate (e.g., create, update, validate, etc.) the CSANR demand models 305.

For example, the NWDAF 140 continuously (or periodically) collects data from network functions within sub-architectures of the network, such as from the core sub-architecture 220, the RAN sub-architecture 250, etc. Typically, such data is collected via standardized service-based interfaces (SBIs), such as where NWDAF 140 is configured as a client of data published or reported by an access and mobility management function (AMF), a session management function (SMF), a user plane function (UPF), and/or other network functions. For example, either in response to requests from the NWDAF 140 and/or in response to certain detected conditions or events, the network functions notify the NWDAF 140 of updated information, and the NWDAF 140 can update and/or generate corresponding performance metrics, usage data, etc. The types of data collected by the NWDAF 140 can include traffic load data (e.g., peak and average traffic loads), QoS metrics (e.g., latency, packet loss, throughput, etc.), device mobility information (e.g., handover rates and patterns), network performance information (e.g., network faults, network errors, performance degradation incidents, etc.), resource utilization metrics (e.g., processing power of network functions, available network function storage, available radio resources in the RAN sub-architecture 250, resource allocation and consumption, etc.), session information (e.g., session establishment success rates, service disruptions, service continuity, etc.), user and application information (e.g., aggregated user demographics, application usage patterns, accessed service types, etc.), etc.

The role of the commoditization processor 320 is to automate functions of a business unit with respect to commoditization and pricing of CSANRs. Embodiments of the commoditization processor 320 automatically generate the CSANR demand models 305 for one or more CSANRs in an environment where supply of and/or demand for those resources are dynamically changing over time. Embodiments of the commoditization processor 320 can then determine pricing for the CSANRs (as commodities) based on the CSANR demand models 305. Inputs to the commoditization processor 320 (e.g., from the NWDAF 140, from prior demand model generation, and/or from other data sources) can include historical demand data, supply data, price history, user behavior and preferences relating to the CSANRs, and/or external factors that can influence demand (e.g., economic indicators, market trends, time zones, seasonal factors, competitive offerings, tenant 360 locations, etc.).

Such inputs can be applied to models, such as statistical models, machine learning algorithms, and/or the like, to forecast demand and thereby generate the CSANR demand models 305. Implementations of the commoditization processor 320 can use time series analyses (e.g., autoregressive integrated moving average (ARIMA) analyses, decomposition analyses, etc.), regression analyses (e.g., linear regression, logistic regression, etc.), machine learning algorithms (e.g., random forest, gradient boosting, neural networks, etc.), and/or other feasible types of analyses to generate CSANR demand models 305. Pricing can be optimized for each CSANR based on balancing a predetermined set of economic metrics. For example, implementations seek to set commodity pricing in a manner that concurrently maximizes a mix of revenue, present utilization of CSANRs, tenant satisfaction, and/or other metrics. Any feasible pricing and/or optimization models can be used. For example, various implementations use one or more of dynamic pricing models to dynamically adjust pricing based on demand elasticity and/or other factors, game theory models to account for competitive pricing strategies of competitors and/or purchasing strategies of tenants, cost-plus pricing models to account for profit margins and mark-ups, value-based pricing to account for perceived value of CSANRs to tenants 360 (e.g., even if inconsistent with the actual value of the resources to the provider), etc.

Outputs from the commoditization processor 320 can include predicted demand of each of some or all of the CSANRs (i.e., the CSANR demand models 305) and a calculated present optimal price for each of some or all of the CSANRs. Some implementations can generate performance metrics relating to revenue, sales volume, market share, and/or other factors that are relevant to evaluating the effectiveness of the pricing strategy. This information can be fed back to the commoditization processor 320 (e.g., to one or more machine learning models) to improve future generation of CSANR demand models 305 and associated present CSANR pricing.

The CSANR demand models 305 and present CSANR pricing can be used to generate one or more present CSANR offers. In some implementations, the CSANR offers are generated by the commoditization processor 320 and output to the pricing API block 330. In other implementations, the commoditization processor 320 outputs present CSANR pricing and/or CSANR demand models 305 to the pricing API block 330, and the pricing API block 330 generates the present CSANR offers, accordingly. In other implementations, the commoditization processor 320 and the pricing API block 330 work together to generate present CSANR offers. In some cases, the present CSANR offers include fixed quantity offers, such as a single unit offer (e.g., one unit of resource A at price X, or other pay-as-you-go pricing) and/or one or more bulk purchase offers (e.g., a fixed quantity, Q>1, units of resource A at a discounted price X). In some cases, the present CSANR offers include subscription-based offers, such as time-based subscriptions (e.g., unlimited access to resource A for a fixed period of time (e.g., the next hour, day, month, etc.) at price X) and/or usage-based subscriptions (e.g., a capped amount of resource A at price X). In some cases, the present CSANR offers include bundled offers, such as mixed resource bundles (e.g., a combination of Q units of resource A and R units of resource B at a bundled price X) and/or customizable bundles. In some cases, the present CSANR offers include dynamic offers, such as time-sensitive discounts (e.g., resource A is at price X during on-peak times, but at a discounted price Y during off-peak times), loyalty-based discounts (e.g., pricing is discounted based on purchase history, customer subscription level, other associated subscriptions, etc.), and/or volume-based discounts (e.g., pricing is discounted based on total volume of resources purchased presently and/or over time). In some cases, the present CSANR offers include tiered pricing offers (e.g., resource A is offered at price X per unit for the first Q units and at a lower price Y for all subsequent units). In some cases, the present CSANR offers include promotional offers, such as introductory offers (e.g., resource A is offered at a reduced price for a period of time for new tenants 360, first-time users of that resource, etc.) and/or cross-sell offers (e.g., resource A is offered at a reduced price when bundled with other products or services).

The arrow labeled ‘[1]’ indicates the commoditization processor 320 passing to the pricing API block 330 any relevant information for generating present CSANR offers. As noted above, this can involve the commoditization processor 320 generating the present CSANR offers and transmitting them to the pricing API block 330, or the commoditization processor 320 transmitting relevant CSANR demand models 305 and/or present CSANR pricing to the pricing API 330. The pricing API 330 provides an interface by which tenants 360 can purchase one or more of the CSANRs based on the present CSANR offers.

Tenants 360 can interact with the pricing API block 330 via any suitable computational platform (not explicitly shown), as indicated by the arrow labeled ‘[2]’. For example, tenants 360 (e.g., human and/or automated agents of tenants 360) have access to one or more portals (e.g., via one or more websites) provided by the pricing API block 330. In some embodiments, the pricing API block 330 is configured for access through stateless RESTful (Representational State Transfer) APIs over (secure) hypertext transfer protocol (HTTP/HTTPS) methods (e.g., GET, POST, PUT, DELETE, etc.). After an application of a tenant 360 computational system authenticates itself (e.g., using tokens, API keys, OAuth, etc.), the application can facilitate communications with and interactions with functions of the pricing API block 330. For example, the application communicates to a related endpoint of the pricing API block 330 using HTTP requests, and the pricing API block 330 communicates to the tenant 360 application using HTTP, JSON, XML, or any other suitable format. In some embodiments, the pricing API block 330 is configured for access through simple object access protocol (SOAP) APIs. A tenant 360 application can authenticate itself (e.g., using WS-Security, or other mechanisms), can send messages to the pricing API block 330 using SOAP envelopes, and can receive messages as SOAP messages. In some embodiments, the pricing API block 330 is configured for command-line interface access, which can involve similar authentication and communication methods to those used by RESTful API implementations. In some embodiments, the pricing API block 330 is configured to interact with specially tailored software development kits (SDKs) and/or libraries running on the tenant 360 computational platforms. In such implementations, the SDKs and/or libraries typically abstract direct interactions with the pricing API block 330 to facilitate more intuitive handling of authentication and communications. In some embodiments, the pricing API block 330 is configured with so-called “webhooks” to enable the pricing API block 330 to proactively send data or notifications to tenant 360 applications (e.g., push notifications, HTTP POST requests, etc.) in response to detecting certain events and/or trigger conditions.

In some embodiments, the pricing API block 330 provides present CSANR offers with predetermined pricing based on the present CSANR pricing, and tenants can decide whether to purchase more or less of offered CSANRs based on the offered pricing. In some implementations, the pricing API block 330 generates, or directs the tenant 360 application to generate, a tenant graphical user interface (GUI) that displays salient information for one or more present CSANR offers. For example, the tenant GUI indicates that resource A is being offered at a unit price of X dollars per unit; a tenant 360 can interface with the pricing API block 330 to purchase Q units of resource A for Q*X dollars. More complex offers can result in more complex tenant GUI displays, more complex interactions between the tenant(s) 360 and the pricing API block 330, etc.

In other embodiments, the pricing API block 330 provides an interface by which tenants 360 can negotiate pricing of offered CSANRs. For example, the same tenant GUI can include a negotiation platform. Some negotiations are provider initiated. Such provider-initiated negotiations can be similar to the present CSANR offers described above, except that the present CSANR pricing is used to generated and provide an opening bid for one or more CSANRs (i.e., a starting price for the negotiation). Other negotiations can be tenant-initiated. In some such tenant-initiated negotiations, the tenant 360 can open the negotiation by requesting an offer and/or a present CSANR pricing for one or more CSANRs. The negotiation can proceed with a provider response, which can include the provider generating and/or providing one or more relevant present CSANR offers, and an associated opening pricing offer based on present CSANR pricing. The provider's response can be generated in the same manner as in the case of a provider-initiated negotiation. In other tenant-initiated negotiations, the tenant 360 can provide an opening bid for one or more CSANRs, including one or more bid parameters (e.g., bid prices, quantities, etc.). The pricing API block 330 can communicate the tenant's 360 bid parameters to the commoditization processor 320, and the commoditization processor 320 can determine whether to accept the tenant's 360 bid parameters based on the CSANR demand models 305. In some cases, if the tenant's 360 bid parameters are rejected, the pricing API block 330 returns a message indicating that the bid was rejected. In some cases, if the tenant's 360 bid parameters are rejected, the commoditization processor 320 generates a counter-bid (e.g., new bid parameters, modifications to the tenant's 360 bid parameters, etc.), and the pricing API block 330 returns a message indicating the new or revised bid. In some cases, the determination of whether to accept or reject a tenant's bid considers additional information, such as the tenant's purchasing patterns, resource usage patterns, subscription type, SLA provisions, etc.

Updated pricing of the CSANRs (i.e., the present CSANR pricing) can be generated and/or provided based on any suitable trigger condition. In some embodiments, some or all trigger conditions are detected by a trigger detector 350. The trigger detector 350 can be implemented as part of the commoditization processor 320, as part of the NWDAF 140, or as a separate component. In some embodiments, present CSANR pricing is generated and/or provided by the commoditization processor 320 and/or the pricing API block 330 periodically, such as once per hour, four times per day, etc. In other embodiments, present CSANR pricing is generated and/or provided by the commoditization processor 320 and/or the pricing API block 330 on request, such as responsive to a tenant 360 submitting a request for updated pricing. In other embodiments, present CSANR pricing is generated and/or provided by the commoditization processor 320 and/or the pricing API block 330 automatically in response to a change in network resource status (e.g., supply and/or demand) exceeding some predetermined threshold. For example, a very popular video streaming event can have a significant impact on demand for network resources. In such a case, some embodiments can trigger updating of present CSANR pricing automatically and proactively based on predicting that change in demand (by the NWDAF 140, or based on knowledge of scheduling, etc.), while other embodiments can update present CSANR pricing automatically and reactively based on detecting the change in demand.

A same CSANR can be priced differently for different tenants 360 (and/or for different verticals, sub-tenants, etc.) at the same time. For example, different tenants 360 or sub-tenants (e.g., a division, branch, cost center, etc. of a company) can be physically situated in different locations, and each different location can be associated with a different local time zones (e.g., at the time of determining the present demand model and/or updated pricing, it may be the middle of the night in one location, but the middle of the day in another location); or different localized demand, or different present or predicted subscriber behavior (e.g., based on occurrence of a major local event). In some embodiments, the commoditization processor 320 generates multiple (e.g., localized, or otherwise more granular) CSANR demand models 305 for the same

CSANR to account for these and/or other differences across tenants 360 or sub-tenants, and the pricing API block 330 can generate appropriate pricing decisions based on the appropriate one of the multiple CSANR demand models 305 for a particular commoditized network resource. In other embodiments, the commoditization processor 320 generates a single CSANR demand model 305 for each CSANR, but each CSANR demand model 305 is generated in a manner that allows the pricing API block 330 (or the commoditization processor 320) to make appropriate pricing adjustments that account for local differences, and/or other relevant factors.

At any particular time, when updated CSANR pricing is available to a tenant 360 via the pricing API block 330, the tenant 360 can determine whether and how to change the amount of one or more CSANRs that is purchased by that tenant 360. For example, in, or in anticipation of, a period of high demand, the unit price for a particular CSANR can increase, and a tenant 360 can decide whether to purchase less of the resource, to remain at a present purchase level, etc. In response to a change in the tenant's 360 purchasing of a particular CSANR (e.g., a change in quantity and/or price), the network orchestrator function 210 can update subscription information, update pricing models, update allocations of resources, etc.

The network orchestrator function 210 issues a request to adjust resource allocations for a particular tenant 360 responsive to updated purchasing of one or more CSANRs by the tenant 360. In some implementations, as indicated by the arrow labeled ‘[3]’, the pricing API block 330 (or other suitable component of the network orchestrator function 210) issues the request to adjust resource allocations via the QoS API 110. Meanwhile, the network orchestrator function 210 can update any other network functions to effect the change in network resource allocations to the tenant 360 (e.g., and/or to particular slices, particular verticals, particular sub-tenants, etc.).

As indicated by label ‘[4]’, the impacted tenant's 360 QoS and/or charging policies will be adjusted based on the updated resource allocations. In some cases, the tenant 360 can subsequently issue one or more requests via the QoS API 110 to adjust one or more encoders, or adjust QoS, etc. within the bounds of updated resource allocations. For example, the tenant 360 can use several mechanisms to reconfigure and/or modifying settings of encoding devices, networking hardware and/or software, or the like, to alter how data is processed and transmitted over the network within the updated resource allocations. Some such reconfigurations and/or modifications can include modifying bitrates and/or adaptive bitrate settings, modifying compression settings, modifying traffic prioritizations, etc. In some cases, such reconfigurations and/or modifications are made using network packet encoders, such as to modify headers, encryption, and/or other packet parameters. In some cases, such reconfigurations and/or modifications can additionally or alternatively involve video encoders, audio encoders, streaming encoders, voice-over-IP encoders, transcoders, and/or any other feasible encoders.

As illustrated, some embodiments include a policing API block 340, which can be implemented as a separate block (e.g., a separate network function), by the QoS API 110 and/or the PCF 130, or in any suitable manner. The policing API block 340 determines whether a requested change in QoS, or the like, can be implemented by the network within any limits of at least the updated resource allocations. For example, if the tenant opts to purchase a smaller quantity of network resources, their QoS may decrease, accordingly; and a subsequent request for increased QoS may be denied by the policing API. Generally, the policing API block 340 seeks to ensure that all tenants 360 adhere to agreed-upon terms for using network resources, including as allocations of those resources change, thereby seeking to prevent any tenant(s) 360 from exceeding their resource allocations (i.e., to the detriment of other tenants 360, network performance, etc.). In response to a change in resource allocations (e.g., after accepting a CSANR offer), a tenant 360 may attempt to increase or decrease its bandwidth usage (e.g., for specific services, across its entire network usage, etc.), to adjust priorities of different data streams (e.g., prioritizing video conferencing over email traffic), to adjust allocations of computing resources (e.g., CPU processing resources, cloud memory resources), to adjust allocations of network resources (e.g., to dedicate particular lanes for particular data transmissions), to add or remove services that rely on network resources, to adjust traffic patterns (e.g., by altering traffic sources, traffic destinations, types of traffic, amounts of domestic and international data flows, etc.), and/or to make other adjustments. The policing API block 340 can evaluate those attempted adjustments based on prior network resource allocations, present and/or modified network resource allocations, pricing policies (e.g., including present CSANR pricing), SLAs (e.g., to ensure that the attempted adjustments do not violate agreed-upon uptime, latency, bandwidth, and/or other service guarantees), overall network performance and integrity, security and compliance requirements, fair usage policies, etc.

Based on the evaluation, the policing API block 340 can determine whether to accept or reject (e.g., or modify) the tenant's 360 request. In some implementations, the policing API block 340 can interface with a tenant's 360 computational platform (e.g., via the tenant GUI, or another GUI) to notify the tenant 360 of the results of the evaluation. If the policing API block 340 determines to allow the attempted adjustment, relevant information is passed on to downstream network functions to realize the tenant's 360 proposed adjustments. If the policing API block 340 determines not to allow the attempted adjustment, the policing API block 340 can notify the tenant 360 (e.g., via the computational platform), and/or can impose restrictions and/or revert the tenant's 360 network usage to a compliant state (e.g., by adjusting parameters, throttling usage, blocking certain types of traffic, charging additional fees, etc.).

In some implementations, rejecting the tenant's 360 proposed adjustments can be a trigger event that triggers the commoditization processor 320 to look for and/or attempt to generate one or more new CSANR offers that would satisfy the tenant's 360 proposed adjustment. Any resulting new CSANR offers can then be displayed to and/or negotiated with the tenant 360 in the manner described herein. In cases where the tenant's 360 attempted adjustments were responsive to (e.g., or within a threshold amount of time subsequent to) an accepted CSANR offer and corresponding update to the tenant's 360 resource allocations (e.g., and/or pricing), implementations can prompt the tenant 360 as to whether the tenant 360 prefers to undo the preceding acceptance and/or purchase and to accept and/or purchase one of the new CSANR offers instead, to ignore new CSANR offers and to propose a different adjustment, etc.

As described above, conventional network implementations offer tenants the ability to purchase levels of QoS, and the network (e.g., the network orchestrator function) can automatically adjust resource allocations in an attempt to satisfy the agreed-upon QoS. In contrast, embodiments described herein offer tenants the ability to purchase commoditized network resources according to dynamic pricing, and the network (e.g., the network orchestrator function) can automatically adjust QoS parameters in an attempt to fit within the purchased resource allocations.

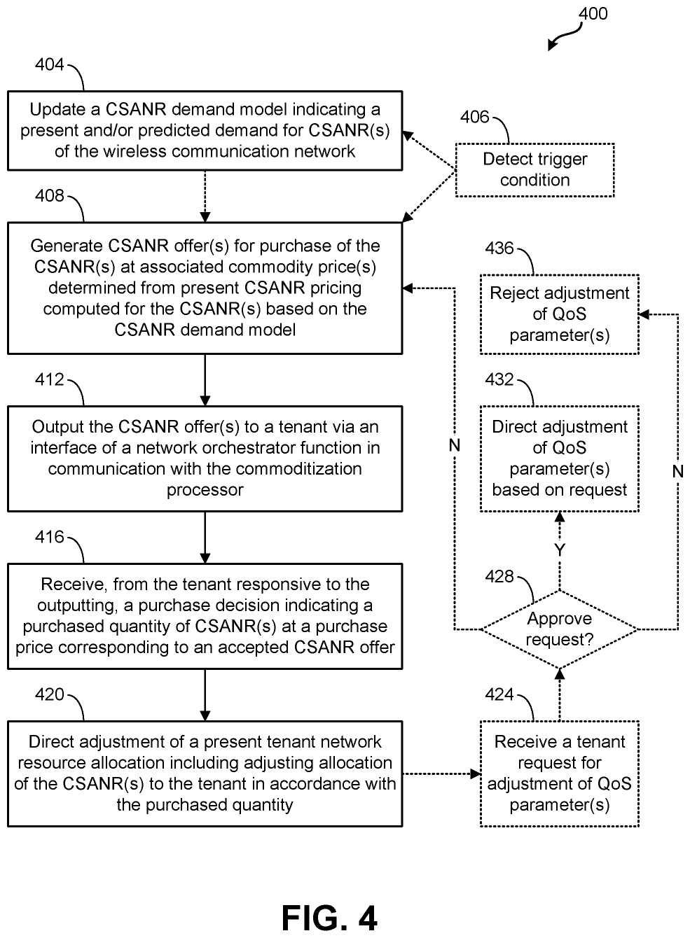

FIG. 4 shows a flow diagram of a method 400 for negotiated allocation of commoditized network resource management in a wireless communication network, according to embodiments described herein. Embodiments can be implemented in any suitable wireless communication network context, such as that of FIG. 3. In some cases, the wireless communication network is a next-generation (e.g., 6G, 7G, etc.) cellular network. Embodiments of the method 400 can begin at stage 404 by updating (e.g., by a commoditization processor based on data obtained from a network data analysis function (NWDAF)), a commoditizable session-allocatable network resource (CSANR) demand model indicating a present and/or predicted demand for one or more CSANRs of the wireless communication network.

At stage 408, embodiments can generate (e.g., by the commoditization processor) one or more CSANR offers for purchase of the one or more CSANRs at an associated one or more commodity prices determined from present CSANR pricing computed for the one or more CSANRs based on the CSANR demand model. In some embodiments, the generating at stage 408 directly follows (e.g., is triggered by) the updating at stage 404. In other embodiments, the generating at stage 408 is separate from the updating at stage 404. For example, the updating at stage 404 occurs periodically, in response to detecting certain trigger conditions at stage 406 (e.g., threshold changes in network resource usage and/or other behaviors, such as detected by the NWDAF), or the like; and the generating at stage 408 occurs based on the same or different periodicity, in response to detecting the same or different trigger conditions at stage 406, or the like.

At stage 412, embodiments can output the one or more CSANR offers to one or more tenants of the wireless communication network. The outputting at stage 412 can be via an interface (e.g., a pricing application programming interface (API) block) of a network orchestrator function in communication with the commoditization processor. As described herein, the outputting at stage 412 can involve communicating with tenant computational platforms to generate GUIs, or the like.

In some cases, the updating at stage 404, the generating at stage 408, and/or the outputting at stage 412 can be responsive to detecting one or more trigger conditions at stage 406. For example, detecting the trigger condition at stage 406 includes detecting a change in the CSANR demand model in excess of a predetermined threshold. Such detection can involve receiving usage data from the NWDAF indicating a change in network resource usage in excess of the predetermined threshold, receiving an explicit indication from the NWDAF of a change in network resource usage in excess of the predetermined threshold, detection of the change in the CSANR demand model in excess of the predetermined threshold upon updating the CSANR demand model at stage 404, etc. Alternatively or additionally, the detected trigger condition at stage 406 can include detecting that a certain amount of time has elapsed since a last performance of stage 404, 408, and/or 412. Alternatively or additionally, the detected trigger condition at stage 406 can include detecting an explicit request by a provider system (e.g., a business unit computational platform) to perform stage 404, 408, and/or 412.

In some embodiments, as described herein, CSANR offers are generated and/or output in conjunction with CSANR bidding. As one example, one or more CSANR offers is output at stage 412, and embodiments subsequently receive one or more counter-offers from one or more tenants. In some such cases, embodiments may generate one or more counter-offers to the tenants' counter-offers, and so on, until a purchase decision is made, all offers are rejected or expire, etc. As another example, the one or more CSANR offers are generated at stage 408 and/or output at stage 412 responsive to an explicit request for offers from a tenant. For example, the tenant can ask generally whether there are any present offers, whether there are any offers relating to a particular one or more CSANRs, etc. As another example, a CSANR bid is received from a tenant, and embodiments determine whether to accept the tenant's bid. Any tenant bid can identify one or more bidded-on CSANRs, one or more bid prices (e.g., a unit price, a price range, etc.) for the CSANR(s), one or more bid quantities (e.g., unit quantities, bulk or bundled quantities, etc.), etc. If not accepted, embodiments can generate one or more counter-offers. Again, one or more subsequent rounds of negotiation may commence until a purchase decision is made, all offers are rejected or expire, etc.

Because the CSANR offers are based on present CSANR demand models and present CSANR resource pricing, any CSANR offers that are generated and/or output to tenants may have associated expiration conditions upon which the offers are no longer valid and can no longer be accepted. For example, the expiration conditions can include an expiration time, a staleness measure, etc. Some embodiments can use information relating to selected, unselected, expired, and/or other previously generated CSANR offers (e.g., via feedback to machine learning algorithms) to improve subsequent generation of offers.

At stage 416, embodiments can receive a purchase decision from the tenant responsive to the outputting at stage 412. The purchase decision can indicate any salient purchase information, including a purchased quantity of at least one of the CSANRs at a purchase price corresponding to an accepted one of the one or more CSANR offers. As described herein, the CSANR offers can be for certain numbers of units of CSANRs at unit prices, bundles of CSANRs at bundled or unit prices, tiered offers, promotional offers, time-bound offers, and/or any other suitable types of commodity offers; and the purchase decision can include any information needed to effect purchase of the selected type of offer.

At stage 420, embodiments direct (e.g., automatically by the network orchestrator function) adjustment of a present tenant network resource allocation including adjusting allocation of the at least one of the CSANRs to the tenant in accordance with the purchased quantity. As described herein, the directing at stage 420 can involve issuing a request to a network exposure function (NEF) to adjust the allocation of the least one of the CSANRs to the tenant based on the purchased quantity.

In some embodiments, the method 400 includes receiving from the tenant, at stage 424, a request for adjustment of one or more quality-of-service (QoS) parameters. The request can be received at a network interface of the wireless communication network, such as at a QoS API, which can be an interface to the NEF. At stage 428, embodiments can determine (e.g., by a policing interface of the wireless communication network, such as a policing API block) whether to permit the request for adjustment based at least on the present tenant network resource allocation. In some embodiments, the request for adjustment is received subsequent to the directing adjustment of the present tenant network resource allocation (i.e., stage 424 follows stage 420), such that the determining whether to permit the request for adjustment is based at least on the present tenant network resource allocation accounting for the adjustment. In other embodiments, the request for adjustment can be received at any feasible time.

If the requested adjustment is accepted at stage 428, embodiments can direct one or more network functions (e.g., the PCF) to carry out the requested adjustment at stage 432. In some embodiments, the directing at stage 432 can include notifying the requesting tenant that the adjustment was accepted and carried out. In some embodiments, if the requested adjustment is not accepted at stage 428, embodiments can simply reject the requested adjustment at stage 436. Such rejecting at stage 436 can include notifying the requesting tenant that the adjustment was rejected and not carried out. In other embodiments, if the requested adjustment is not accepted at stage 428, embodiments can use that as a trigger to generate one or more CSANR offers at stage 408 and/or output one or more CSANR offers at stage 412. In some such embodiments, the triggered (generated and/or output) CSANR offers include one or more CSANR offers that seek to accommodate the request for adjustment. For example, a tenant's present resource allocation does not support the tenant's proposed QoS adjustment, but embodiments can generate one or more CSANR offers based on present CSANR demand models and present CSANR resource pricing which, if purchased, would be able to accommodate the tenant's proposed QoS adjustment.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for negotiated allocation of commoditized network resource management in a wireless communication network, the method comprising:
updating, by a commoditization processor based on data obtained from a network data analysis function (NWDAF), a commoditizable session-allocatable network resource (CSANR) demand model indicating a present and/or predicted demand for one or more CSANRs of the wireless communication network;
generating, by the commoditization processor, one or more CSANR offers for purchase of the one or more CSANRs at an associated one or more commodity prices determined from present CSANR pricing computed for the one or more CSANRs based on the CSANR demand model;
outputting the one or more CSANR offers to a tenant of the wireless communication network via an interface of a network orchestrator function in communication with the commoditization processor;
receiving, from the tenant responsive to the outputting, a purchase decision indicating a purchased quantity of at least one of the CSANRs at a purchase price corresponding to an accepted one of the one or more CSANR offers; and
directing, automatically by the network orchestrator function, adjustment of a present tenant network resource allocation including adjusting allocation of the at least one of the CSANRs to the tenant in accordance with the purchased quantity.

2. The method of claim 1, wherein the directing the adjustment of the present tenant network resource allocation comprises issuing a request to a network exposure function (NEF) to adjust the allocation of the least one of the CSANRs to the tenant based on the purchased quantity.

3. The method of claim 1, further comprising:
receiving, from the tenant at a network interface of the wireless communication network, a request for adjustment of one or more quality-of-service (QoS) parameters; and
determining, by a policing interface of the wireless communication network, whether to permit the request for adjustment based at least on the present tenant network resource allocation.

4. The method of claim 3, wherein:
the request for adjustment is received subsequent to the directing adjustment of the present tenant network resource allocation, such that the determining whether to permit the request for adjustment is based at least on the present tenant network resource allocation accounting for the adjustment.

5. The method of claim 3, wherein:
the request for adjustment is received prior to the generating the one or more CSANR offers;
the generating the one or more CSANR offers is responsive to determining not to permit the request for adjustment; and
the generating the one or more CSANR offers comprises generating at least one CSANR offer that accommodates the request for adjustment.

6. The method of claim 1, wherein the generating the one or more CSANR offers comprises:
detecting, based on the updating the CSANR demand model, a change in the CSANR demand model in excess of a predetermined threshold; and
automatically generating the one or more CSANR offers responsive to the detecting.

7. The method of claim 1, wherein the generating the one or more CSANR offers comprises:
receiving a request for a CSANR offer from the tenant; and
generating the one or more CSANR offers automatically in response to and based on the request.

8. The method of claim 7, wherein:
the request for the CSANR offer includes a tenant-initiated bid for a bidded-on CSANR at a bidded-on commodity price.

9. The method of claim 8, wherein the generating the one or more CSANR offers comprises generating at least one CSANR offer that is a counter-bid to the tenant-initiated bid.

10. The method of claim 1, wherein at least one of the one or more CSANR offers is for purchase of defined units of an indicated one of the CSANRs at an indicated unit price.

11. A system for negotiated allocation of commoditized network resource management in a wireless communication network, the system comprising:
a commoditization processor configured to:
update, based on data obtained from a network data analysis function (NWDAF), a commoditizable session-allocatable network resource (CSANR) demand model indicating a present and/or predicted demand for one or more CSANRs of the wireless communication network; and
generate one or more CSANR offers for purchase of the one or more CSANRs at an associated one or more commodity prices determined from present CSANR pricing computed for the one or more CSANRs based on the CSANR demand model;
a network orchestrator function of the wireless communication network in communication with the commoditization processor and configured to:
output the CSANR offer to a computational platform of a tenant of the wireless communication network;
receive, from the tenant responsive to the outputting, a purchase decision indicating a purchased quantity of at least one of the CSANRs at a purchase price corresponding to an accepted one of the one or more CSANR offers; and
direct adjustment of a present tenant network resource allocation via an interface to a network exposure function (NEF) of the wireless communication network, including adjusting allocation of the at least one of the CSANRs to the tenant in accordance with the purchased quantity.

12. The system of claim 11, wherein the network orchestrator function comprises a pricing interface block configured to interface communications between the network orchestrator function, the commoditization processor, the computational platform of the tenant, and the QoS interface.

13. The system of claim 11, further comprising:
the NWDAF;
the NEF; and
a policy control function (PCF) coupled with the NWDAF, the NEF, and a cellular core network.

14. The system of claim 13, wherein the cellular core network is a sixth generation (6G) cellular core network.

15. The system of claim 13, further comprising:
a policing interface block coupled with the PCF and configured to:
receive a request for adjustment of one or more quality-of-service (QoS) parameters from the tenant; and
determine whether to permit the request for adjustment based at least on the present tenant network resource allocation.

16. The system of claim 15, wherein:
the request for adjustment is received subsequent to the network orchestrator function directing adjustment of the present tenant network resource allocation, such that the policing interface block determining whether to permit the request for adjustment is based at least on the present tenant network resource allocation accounting for the adjustment.

17. The system of claim 15, wherein:
the request for adjustment is received prior to the network orchestrator function generating the one or more CSANR offers;
the commoditization processor is configured to generate the one or more CSANR offers responsive to determining not to permit the request for adjustment; and
the commoditization processor is configured to generate the one or more CSANR offers to comprise at least one CSANR offer that accommodates the request for adjustment.

18. The system of claim 11, wherein the commoditization processor is configured to generate the one or more CSANR offers by:
detecting, based on the updating the CSANR demand model, a change in the CSANR demand model in excess of a predetermined threshold; and
automatically generating the one or more CSANR offers responsive to the detecting.

19. The system of claim 11, wherein the commoditization processor is configured to generate the one or more CSANR offers by:
receiving a request for a CSANR offer from the tenant; and
generating the one or more CSANR offers automatically in response to and based on the request.

20. The system of claim 19, wherein:
the request for the CSANR offer includes a tenant-initiated bid for a bidded-on CSANR at a bidded-on commodity price.
